(19) United States
(12) Patent Application Publication
(10) Pub. No.: US 2002/0147644 A1
(43) Pub. Date: Oct. 10, 2002

(54) System and method for managing and utilizing location and time-based information

(76) Inventors: Ragavan Subramanian, San Francisco, CA (US); Sandeep Kishen Mirchandani, Fremont, CA (US); Gregory James Kemnitz, Mtn View, CA (US); Vikram Koka, Fremont, CA (US); Neeray Berry, Menlo Park, CA (US)

Correspondence Address: GARY CARY WARE & FREIDENRICH LLP, 1755 EMBARCADERO ROAD, PALO ALTO, CA, 94303-3340, US

(21) Appl. No.: 10/014,122

(22) Filed: Dec. 11, 2001

Related U.S. Application Data
(60) Provisional application No. 60/255,048, filed on Dec. 11, 2000.

(51) Int. Cl. G06F 17/60

(52) U.S. Cl. 705/14; 707/3

(57) ABSTRACT

A system 10 for managing and utilizing location and time-based information. The system 10 may be implemented over wireless and wired networks 20, and is effective to allow an enterprise to associate location and time with any data elements stored within the system, thereby enabling enterprises to deliver location and time-based information, transactions and communications to mobile and non-mobile business users. The system 10 allows each of the data elements to be associated with a time, which may be selectively defined as fixed, relative to a user, or relative to said system. The system 10 further allows data elements to be created with a plurality of user-definable attributes, which may be defined as fixed or as dynamic rules that are embedded as part of the data elements. The system 10 performs intersect queries to quickly retrieve data elements.

### FIELD OF THE INVENTION

The present invention generally relates to a system and method for managing and utilizing location and time-based information and more particularly, to a system and method that allows enterprises to manage and utilize location and time-based information in a meaningful manner, thereby enabling such enterprises to deliver location and time-based information, transactions and communications to mobile and non-mobile business users.

### BACKGROUND OF THE INVENTION

Mobile devices and applications have increased the need and desire for enterprises to manage and utilize location and time-based information for interacting with mobile business users (e.g., customers, employees and other users). Non-mobile business users are also increasingly looking for location and time-based information, such as location and availability of stores, products and promotions. Enterprises presently receive and utilize information regarding the basic location of business users, such as the area (e.g., city/state, ZIP code, or latitude/longitude) in which the business users presently reside. Enterprises typically obtain this location-based information in a conventional manner, such as from the wireless networks on which a business user operates (e.g., by way of wireless phone, personal digital assistant (PDA), web-enabled phone or pagers, or any other suitable mobile device) or from the user himself (e.g., user entering a ZIP code or city on an internet site). In a similar manner, enterprises may receive basic temporal information regarding business users from wireless networks or from the user himself, such as the user's local time.

This basic or “raw” location and time-based information is of limited use, and must be subsequently processed and analyzed by an enterprise to determine its potential relevance and to allow the enterprise to properly utilize the information to interact with customers or end-users. As a result, enterprises often have difficulty in implementing this information in a meaningful way in order to further their needs and goals of interacting with end-users.

It is therefore desirable to provide a system and method for managing and utilizing location and time-based information, which automatically maps location and time-based information regarding mobile business users to various enterprise data, thereby enabling enterprises to immediately utilize and provide information in a useful and relevant manner.

### SUMMARY OF THE INVENTION

One non-limiting advantage of the present invention is that it provides a system and method for managing and utilizing location and time-based information, which allows an enterprise to use the information to interact with end-users. By way of example and without limitation, the system and method allows an enterprise to associate location and time with any data elements within the system, thereby allowing data elements to be related by location and time and enabling enterprises to deliver location and time-based information, transactions and communications to mobile business users.

Another non-limiting advantage of the present invention is that it provides a system and method for managing and utilizing location and time-based information, including a configurable location scheme which is customizable by a user of the system (e.g., an enterprise), which allows locations to be mapped in a hierarchical manner, and which allows multiple locations schemes or hierarchies to be defined.

Another non-limiting advantage of the present invention is that it provides a system and method for managing and utilizing location and time-based information that allows location and time to be mapped to any data in the system, such as data relating to products, content, customers, end-users, assets and editorial content, where such data is definable by the user. The present invention further allows multiple locations values to be mapped into each data element.

Another non-limiting advantage of the present invention is that it provides a system and method for managing and utilizing location and time-based information that allows for the fast computation of location overlap between data elements, which may be mapped to the same or different location hierarchies. For example, the system can determine what promotions are applicable to a particular store by determining a location overlap between stores, which are mapped to a distribution hierarchy, and promotions, which are mapped to a promotional hierarchy.

Another non-limiting advantage of the present invention is that it allows data elements to be defined dynamically, based upon certain rules that are stored as part of the data elements. For example, the price of a product can be defined as a rule based on the user's current location, time and contractual status with the enterprise.

According to one aspect of the present invention, a system for managing and utilizing location-based information is provided. The system is adapted to create a plurality of interrelated location hierarchies, to create a plurality of data types each having user-definable attributes, to create data records within the plurality of data types by providing values for the user-definable attributes, to map the data records into the location hierarchies, to create relationships between the data types and records, and to perform location intersect queries for quickly retrieving data records.

According to another aspect of the present invention, a system is provided for managing and utilizing time-based information. The system is adapted to create a create a plurality of data elements which may each be associated with a time, wherein the time may be selectively defined as fixed, relative to a user, and relative to the system, and to perform queries for quickly retrieving the data elements based upon time.

According to another aspect of the present invention, a system for managing and utilizing information is provided. The system is adapted to create a plurality of data elements each including a plurality of user-definable attributes, wherein each of the attributes may be defined as fixed or as a dynamic rule that is embedded as part of the data element and that includes at least one variable, and to perform queries that run the dynamic rules in order to quickly retrieve data elements.

According to another aspect of the present invention, a system for managing and utilizing location and time-based information is provided. The system includes a first portion adapted to receive location information, and to create a plurality of interrelated location hierarchies based upon the location information; a second portion adapted to receive content information, and to create a plurality of content types based upon the content information, each of the content types including a plurality of attributes; a third portion adapted to receive relationship information, and to create relationships between different content types; a fourth portion adapted to create data records within the plurality of content types, by providing values for attributes of the plurality of content types; a fifth portion adapted to associate the data records to locations within the plurality of interrelated location hierarchies; and a sixth portion adapted to receive location and time-based queries and to retrieve relevant data records, based upon the queries.

According to another aspect of the present invention, a method is provided for managing and utilizing location and time-based information. The method includes the steps of: creating a plurality of interrelated location hierarchies; creating a plurality of data types each having user-definable attributes; creating data records within the plurality of data types by providing values for the user-definable attributes; mapping the data records into the location hierarchies; creating relationships between the data types and records; and performing location intersect queries for quickly retrieving data records.

These and other features and advantages of the invention will become apparent by reference to the following specification and by reference to the following drawings.

### BRIEF DESCRIPTION OF THE DRAWINGS

FIG. 1 is a block diagram of a system for managing and utilizing location and time-based information in accordance with a preferred embodiment of the present invention.

FIG. 2 is a block diagram illustrating the method used with the present invention in order to create a system for managing and utilizing location and time-based information.

FIG. 3 is a graphical representation of several location hierarchies that may be created and implemented by the present invention in a retail environment.

FIGS. 4-8 are some non-limiting examples of graphical user interfaces that may be presented by the system in order to create location hierarchies.

FIGS. 9-12 are some non-limiting examples of user interfaces that may be presented by the system in order to create content types.

FIGS. 13-15 are some non-limiting examples of user interfaces that may be presented by the system in order to create relationships between different content types.

FIGS. 16-17 are some non-limiting examples of user interfaces that may be presented by the system in order to create content or data records.

FIG. 18 is a non-limiting example of a user interface for creating a mapping between a store (which is a data record within the retail store content type) and a location within the distribution hierarchy.

FIG. 19 is a non-limiting example of a user interface for creating a mapping between a product (which is a data record within the retail product content type) and a store (which is a data record within the retail store content type).

FIG. 20 is a non-limiting example of a user-interface for defining extended attributes of a relationship. In this example, inventory is an extended attribute of the relationship between stores and products.

FIGS. 21-26 illustrate a series of sample screens that may be generated by the system for the creation of a macro-rule.

FIG. 27 illustrates a graphical representation of a dynamic, relational data system that may be created by use of the present invention.

FIG. 28 is a graphical representation illustrating an example of the operational flow of the system in determining the location intersection between data records of two different content types.

### DETAILED DESCRIPTION OF A PREFERRED EMBODIMENT OF THE INVENTION

The present invention provides a system and method for managing and utilizing location and time-based information. The present invention enables an enterprise to deliver location and time-based content, transactions and communications to end-users over both mobile and non-mobile devices. In the preferred embodiment, the system and method are implemented on one or more computer systems and networks, and are designed to provide location and time-based information in a manner useful and relevant to enterprises and end-users. The system and method may comprise hardware and software components that may be implemented within at least one computer system or network (e.g., a plurality of cooperatively linked computers).

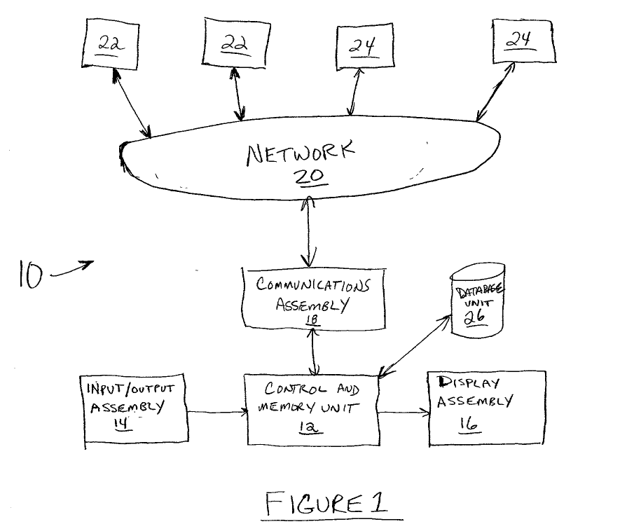

FIG. 1 illustrates a system 10 for managing and utilizing location and time-based information, which is implemented on a computer system in accordance with the present invention. System 10 may represent a conventional and commercially available computer system or an independent microprocessor-based system built specifically for use with the present invention. System 10 includes a control and memory unit 12, a input/output assembly 14, a visual display assembly 16, a communications assembly 18, and a database unit 26. The system 10 is adapted to be communicatively coupled to one or more networks 20, which may comprise global and/or local area wireless networks, along with conventional wired networks, such as the internet. Users may communicate with system 10 over networks 20 in a conventional manner by use of wireless devices 22 and wired communication devices 24. In the preferred embodiment, networks 20 are effective to communicate basic location and time information to system 10, describing the current time that a user is on the network 20, and a general location (e.g., region, latitude/longitude) of the user that is logged onto the network 20.

Control and memory unit 12 may be a conventional and commercially available processor-based system or server, including a microprocessor, both volatile and non-volatile memory, and one or more persistent storage devices. In the preferred embodiment, control and memory unit 12 is adapted to and may store at least a portion of the operating software which controls the operation of system 10. Alternatively, the present invention may be stored on remote systems or devices, and may be accessed and loaded into control and memory unit 12 by way of user input/output assembly 14 and/or communications assembly 18. As described more fully and completely below, enterprises may use control and memory unit 12 and database unit 26 to create, store and deploy location and time-based relationships, rules, hierarchies and content that may be utilized by the system 10 for interaction with end-users.

Control and memory unit 12 is communicatively coupled to database unit 26, which may comprise a conventional relational database adapted to persistently store data entered into system 10. In addition, database unit 26 may be augmented with another conventional device or application adapted to store data in a relational manner.

Input/output assembly 14 may include one or more conventional and commercially available devices adapted to allow an enterprise, user or system administrator to provide data to, and access data from, control and memory unit 12, and may comprise without limitation conventional user input assemblies, such as a keyboard, mouse, or touch pad. Input/output assemblies 14 may further include other conventional peripheral devices such as disk drives, printers, scanners and the like. Display assembly 16 may be a conventional and commercially available device for allowing system 10 to display visual data and graphical user interfaces to an enterprise, user or system administrator. The display assembly 16 may include a computer monitor, a flat panel display or other conventional display device which is suitable to display output generated by computer system 10. It should be appreciated that the user input/output assembly 14 and the display assembly 16 cooperatively permit an enterprise or system administrator to enter and/or modify data within system 10, to visually develop hierarchies, content, rules and applications with system 10, to access data from system 10, and to perform system maintenance, management and modification. It should further be appreciated that mobile and wired users communicating with system 10 will also typically have such conventional input/output and display assemblies available through their respective wireless devices 22 and wired devices 24.

Communications assembly 18 may be a suitable and commercially available device or a combination of devices for transferring data over wireless and wired communications networks 20, such as modems, transmitters, receivers and the like. Communications assembly 18 allows system 10 to communicate and interact with end-users by way of conventional wireless devices 22 and wired devices 24. Wireless devices 22 may be any conventional and commercially available wireless devices, such as mobile phones, internet-enabled phones, pagers, PDAs and any other suitable wireless devices. Wired devices 24 may be any conventional and commercially available devices that may be physically connected to a wired network, such as personal computers, laptop and notebook computers, land-line phones (e.g., connected to the PSTN network) and any other suitable wired devices.

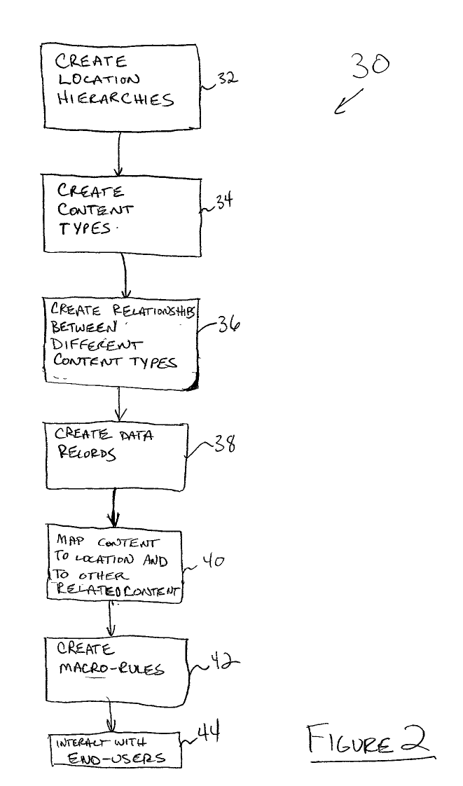

To better understand the operation of the preferred embodiment of the invention, reference is now made to FIG. 2, which illustrates a block diagram 30 demonstrating the functionality, method or strategy in which system 10 may be employed to manage and utilize location and time-based information. The method 30 is briefly executed as follows: (i) a user (e.g., an enterprise) creates one or more location hierarchies within system 10 in functional block or step 32; (ii) the user creates content types within system 10 in functional block or step 34; (iii) the user creates relationships between different content types in functional block or step 36; (iv) the user creates data records and associated micro-rules within the content types in functional block or step 38; (v) the user maps content to locations within the hierarchies and maps content to other related content in functional block or step 40; (vi) the user creates macro-rules in functional block or step 42; and (vii) the system interacts with end-users by use of the previously created location hierarchies, content types, data records mapping information, and rules in functional block or step 44. The function and/or operation of each of the foregoing steps is discussed more fully and completely below.

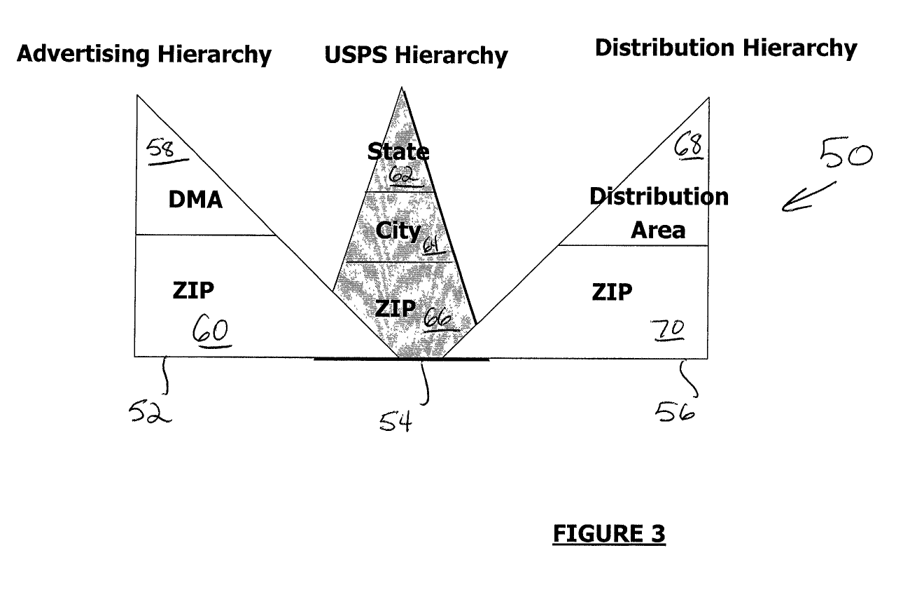

For purposes of illustration, the following discussion includes a description of the present invention being implemented in a retail business environment. However, it should be appreciated that the present invention may be equally applicable to any other business environments and contexts in which an enterprise desires to manage and utilize location and time-based information for interacting with a plurality of mobile and/or non-mobile users. In functional block or step 32, a user employs system 10 to create a plurality of interrelatable location hierarchies, based upon considerations and needs that are relevant to the user or enterprise. System 10 allows a user to create or define multiple location hierarchies. For example and without limitation, FIG. 3 illustrates a retail hierarchy scheme 50 that may be implemented by the present invention, including an advertising hierarchy 52, an end-user, geographic or U.S. postal service (“USPS”) hierarchy 54, and a distribution hierarchy 56. As illustrated in FIG. 3, the location hierarchies, 52-56 overlap, thereby allowing information within the hierarchies to be interrelated.

The implementation of certain advertisements and marketing promotions may be managed by use of the advertising location hierarchy 52. The use of an advertising hierarchy 52 allows a user or enterprise to manage marketing promotions that may be based or dependent upon a given direct marketing area (DMA) 58 (e.g., New York City, Chicago or San Francisco Bay Area). For instance, the advertising hierarchy will allow a user or enterprise to make certain marketing promotions available only in certain direct marketing areas 58. The direct marketing areas 58 are a subset of and are in turn comprised of ZIP codes 60 which fall within each direct marketing area 58. The USPS hierarchy 54 contains information relating to uniform postal codes which may represent, by way of example and without limitation, possible locations of end-users of the system 10. In one non-limiting embodiment, the USPS hierarchy 54 may include levels representing States 62, Cities 64, and ZIP codes 66. Finally, the location of retail stores may be set forth in a retail distribution hierarchy 56, where each store is mapped to the distribution area 68 it serves, and a set of ZIP codes 70 within the distribution areas. For example, a store located in East Palo Alto, Calif. may be designed to serve a range of ZIP codes in the surrounding cities of Palo Alto, Menlo Park, Redwood City and others.

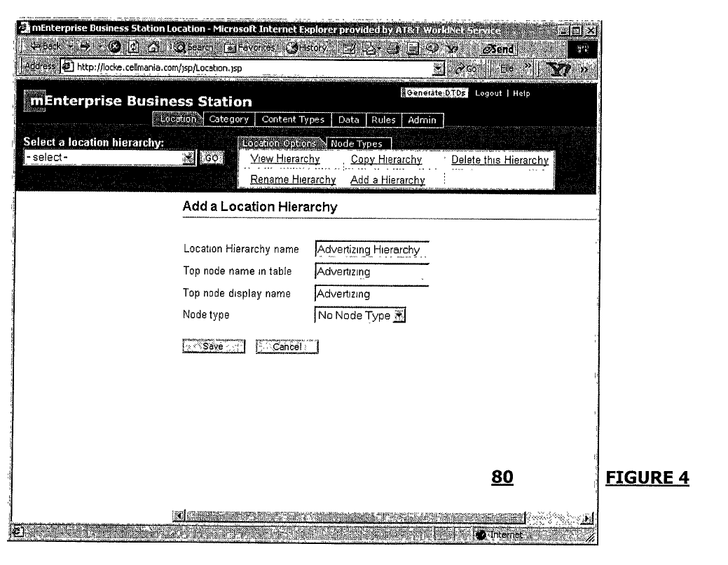

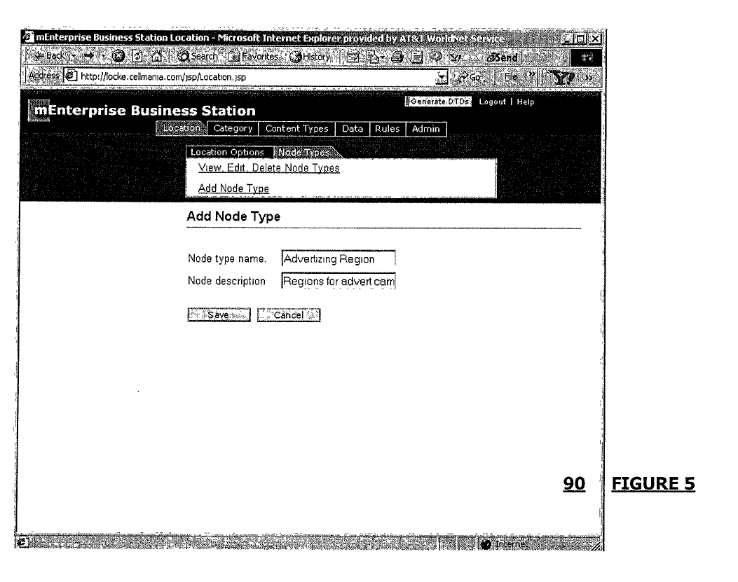

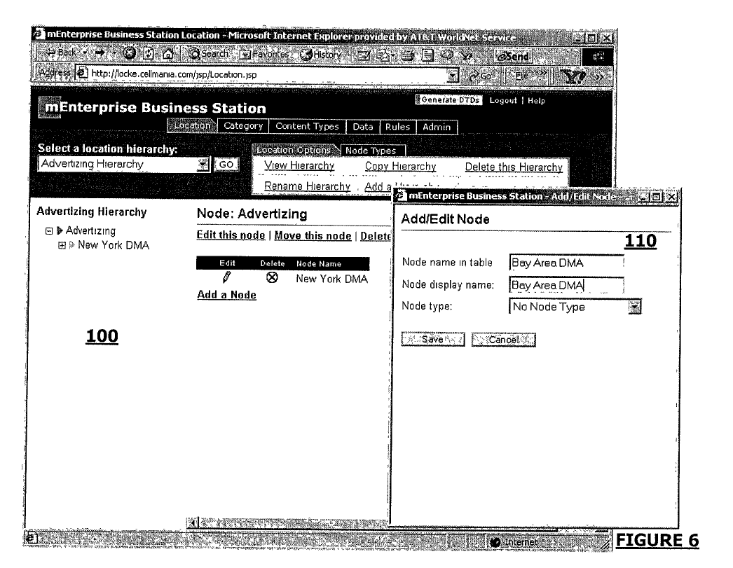

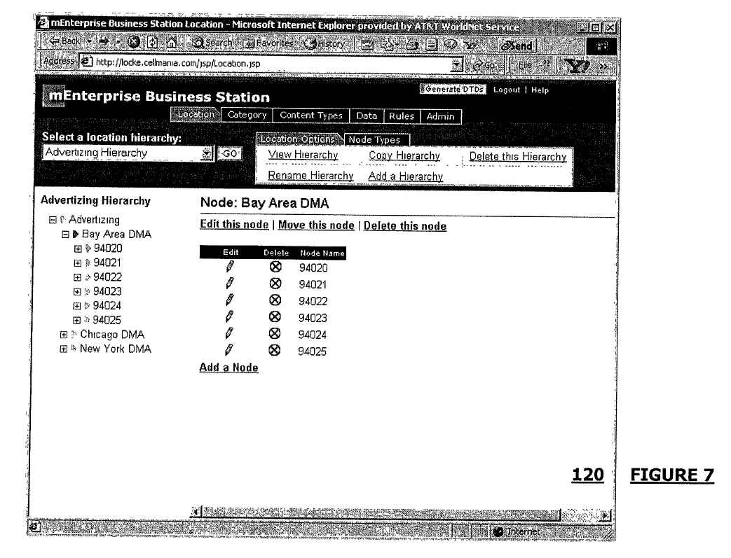

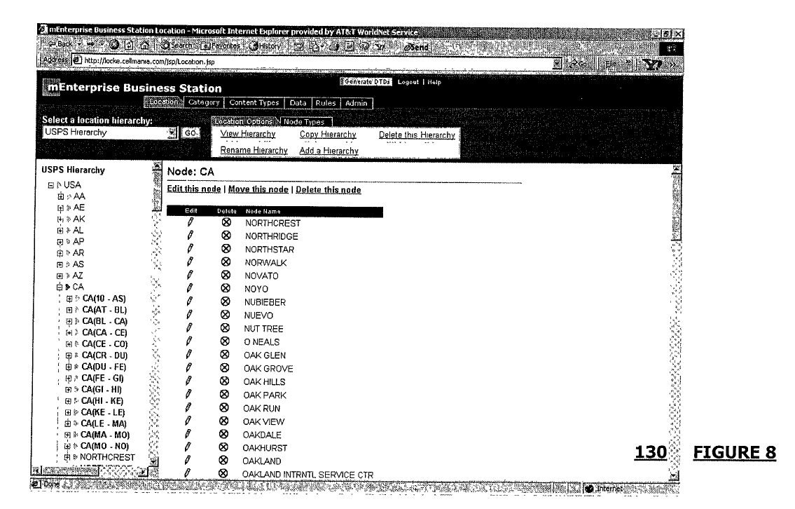

FIGS. 4-8 illustrate some non-limiting examples of graphical user interfaces (GUIs) or query screens that may be presented by system 10 in order to gather location hierarchy information from users or enterprises. FIG. 4 illustrates one non-limiting example of an initial interface or screen 80 for creating or adding a hierarchy. In the preferred embodiment, system 10 allows a user to create or add a location hierarchy by selecting or clicking the text “Add a Hierarchy.” The system 10 will query the user for a location hierarchy name, a top node name, a top node display name (which may typically be the same as the top node name), and a node type (since no node types have been created for this example, the user may leave this option blank), as shown in screen 80. In the example shown, an advertising hierarchy is created with “Advertising” as the top node and display name. Upon entry of the relevant information, a user will select the “Save” option, and system 10 will store the entered information and generate user interface or screen 90, shown in FIG. 5. Screen 90 allows a user to add node types to the location hierarchy. Particularly, the user may define nodes by selecting the text “Add Node Type,” entering the node type name (e.g., “Advertising Region”), and the node description (e.g., regions for advertising campaigns). Node types can be used to represent different types of nodes in the hierarchy. For example, Advertising Region and ZIP code could be two different node types within the advertising hierarchy, and 94025 and 94026 could be two nodes of the ZIP code node type. Upon entry of the relevant information, a user will select the “Save” option, and system 10 will store the entered information and generate user interface or screen 100, shown in FIG. 6. Screen 100 allows a user to create nodes within the previously created node type. As shown in the left portion of screen 100, the system 100 displays, by name, the hierarchy and nodes. The “advertising region” nodes are created below the top node, which is “Advertising.” Screen 100 illustrates a node created for the New York district marketing area (“New York DMA”), and “pop-up” screen 110 shows a node being created for the San Francisco Bay Area marketing area (“Bay Area DMA”). After each node is saved, a user may select the “Add a Node” option to create additional nodes that map to the same parent node in the hierarchy. The user may then create additional nodes below the present node (e.g., by use of screen 100), in the previously described manner. For example, a user may create nodes representing the ZIP codes within each advertising region, as shown in screen 120 of FIG. 7. Screen 130 of FIG. 8 illustrates a portion of the USPS hierarchy, including nodes representing States and Cities, which may be created or built in the previously described manner.

After all necessary and/or desired location hierarchies are created, a user will typically proceed to functional block or step 34 (see FIG. 2), where the user employs system 10 to create content types for representing the different types of data to be used by the system 10. It should be appreciated that a user may perform the steps of the method 30 in a different order. For example, a user could define location hierarchies after defining content types. Subsequently (e.g., in step 38), the user may create specific data records within the created content types.

System 10 supports user-definable content types, which are created, in the preferred embodiment, by use of a GUI tool. Each content type created has a set of user-definable attributes. In a retail environment, examples of content types may be products, customers, stores, and warehouses. Examples of attributes of a content type, such as a “product” content type, may include price, name, stock keeping unit (“SKU”), and manufacturer. These attributes may be defined as a fixed data type (for example, string, integer, float, date, time) or as dynamic data by use of “micro-rules.”

The ability to create micro-rules and macro-rules (defined later), which is provided by system 10, allows the value of an attribute of a content type to be dynamic. Particularly, micro-rules allow each attribute may selectively be based upon a user-defined, multi-variable formula. As a result, the system 10 provides unique and significant advantages over prior engines and applications, which do not allow values of attributes to be based on formulas. For example, in the “product” content type, the attribute of price can be defined as a micro-rule based on a number of variables, such as, location, time, customer contract, quantity being purchased, or any variable or attribute in an end-user's profile (i.e., data describing an end-user which may be provided by an end-user or otherwise obtained by an enterprise or a system administrator in a conventional manner), in an end-user's session (i.e., historical data relating to an end-user's interaction with the system that is stored by system 10 whenever an end-user logs onto the system 10), or in a content type. Each product attribute may have a different embedded micro-rule. For the same attribute, each data record may have a different micro-rule. For example, the pricing micro-rule for each product may be different. In one non-limiting embodiment, these rules may be defined or specified in a rule language (which is like a conventional programming language such as C) developed specifically for use with the present invention. The micro-rules provided by system 10 allow business logic to be altered very quickly by business managers or system administrators, who can create and change these rules anytime (without having to bring down and restart the system) by logging onto the system 10 (e.g., by use of input/output assembly 14), rather than having to integrate each rule into code, which would require developers to change an entire application and to restart the application. The creation and use of micro-rules will be described more fully and completely below in relation to step 38.

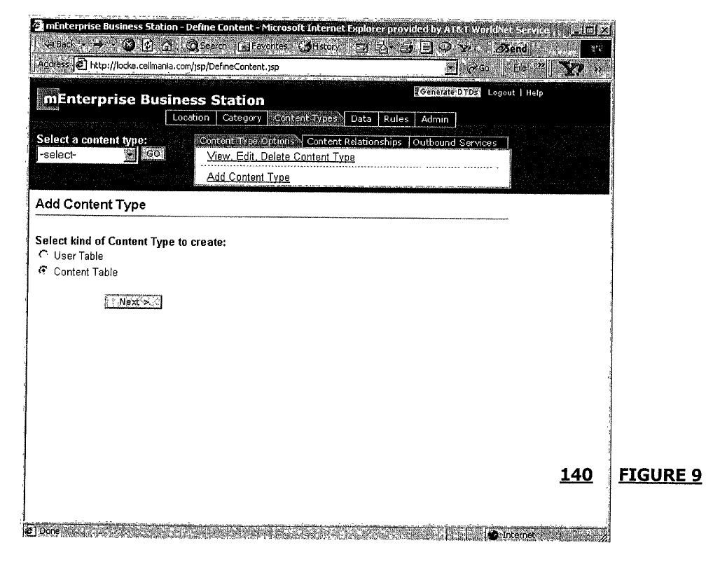

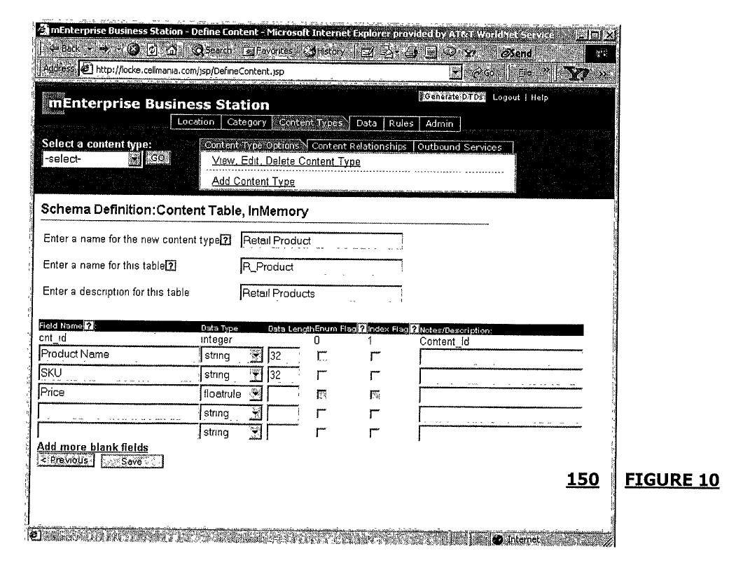

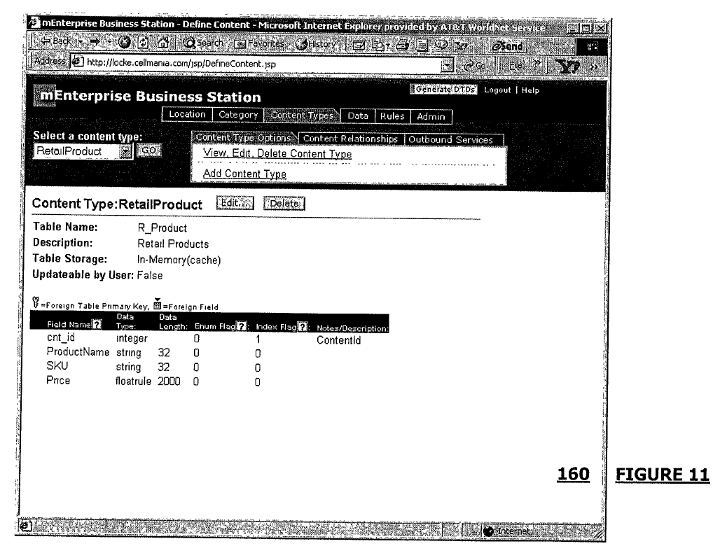

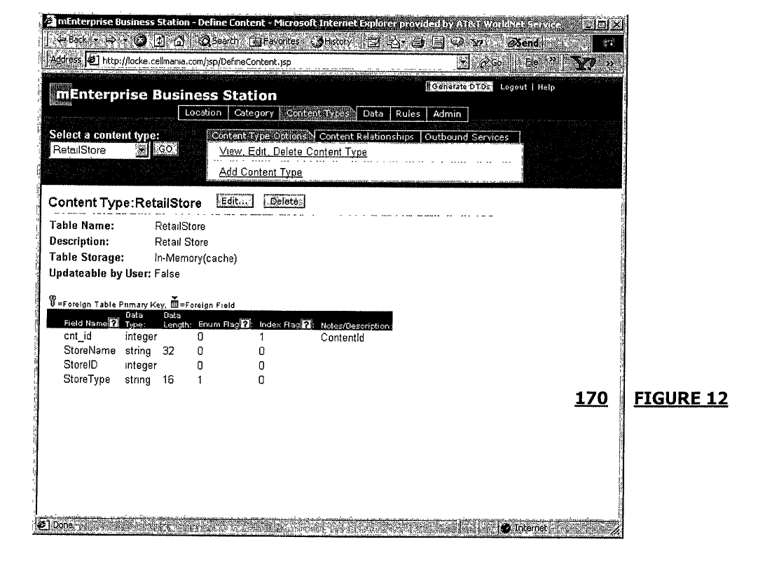

FIGS. 9-12 illustrate some non-limiting examples of user interfaces or screens that may be presented by system 10 in order to create content types. FIG. 9 illustrates one non-limiting example of an initial interface or screen 140 for creating a content type. Screen 140 allows a user to select to create either a “user table” (for end-user related data), or a “content table” (for enterprise data). Once a user has entered a selection, system 10 will display user interface or screen 150 of FIG. 10, which allows the user to name the content type and define the attributes for that content type. As shown, screen 150 allows a user to name the content type and the table created for the content type (e.g., “Retail Product”/“R_Product”), and to enter a description of the contents of the table (e.g., “Retail Products”). Below the foregoing entries, screen 150 includes a plurality of blank fields, in which the user may enter or define attributes for the content type. As shown in the entries underneath the text “Data Type,” the attributes may be created as either conventional data types, such as integer (“integer”), string (“string”), float, or data, or as a micro-rule (i.e., “floatrule”, “intrule”, “stringrule”). Once a content type has been created, system 10 will display a screen illustrating the created content type. One non-limiting example is screen 160 of FIG. 11, which illustrates a content type created for retail products (“Retail Products”), having the following attributes: content identification number (“cnt_id”), product name (“ProductName”), stock keeping unit (“SKU”), and price (“Price”). Screen 170 of FIG. 12 illustrates a content type created for retail stores (“Retail Store”), having the following attributes: content identification number (“cnt_id”), store name (“StoreName”), store identification number (“StoreID”), and store type (“StoreType”). It should be appreciated that this content type has been defined as an “in-memory” content type, which means that the system 10 will cache the data within its internal memory and can perform (micro and macro) rules and location-intersection operations very fast. The alternative would be to define the content type as “not in-memory,” where the data would not be cached by the system 10 and would be stored in a database (e.g., database unit 26) or an external system. In the preferred embodiment, content types that are “not in-memory” cannot use rules and location relationships, but can use content-to-content relationships. Screens 160 and 170 also allow a user to edit or delete the respective content types, and to add additional content types (e.g., by selecting the corresponding areas or text of screens 160 and 170).

After the content types are created, a user will proceed to functional block or step 36, where the user employs system 10 to create relationships between different content types. Particularly, system 10 allows a user or enterprise to create relationships between one content type and another, such as between retail products and retail stores (e.g., so that specific products can be related to specific stores that carry those products). Furthermore, the created relationships can be assigned one or more extended attributes. For example, inventory may be an extended attribute of the relationship between retail stores and retail products, and may be used to indicate the quantity of a given product that is in a given store (e.g., by mapping the product to the store).

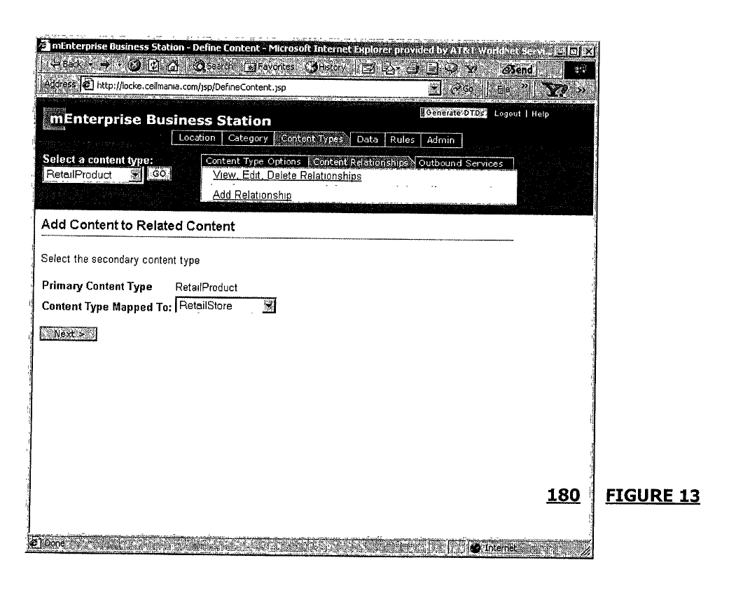

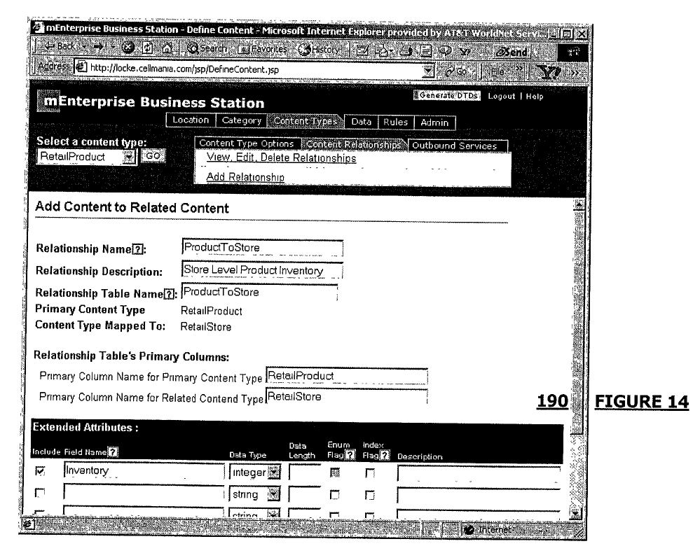

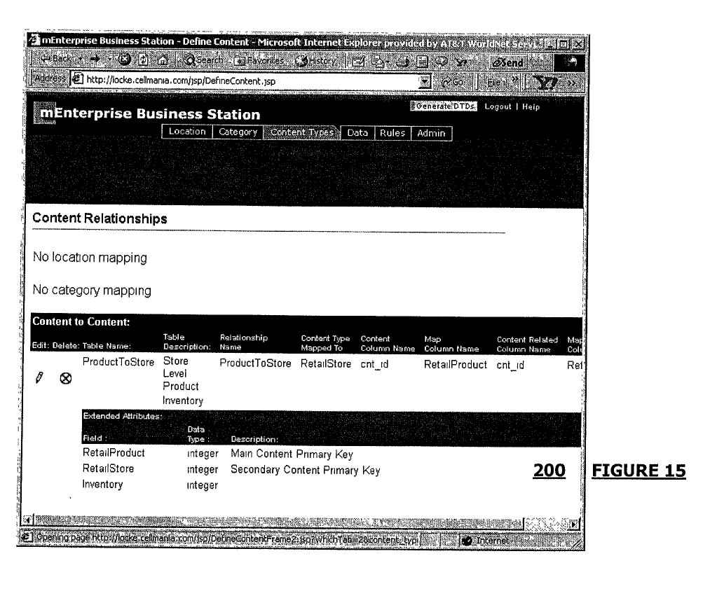

FIGS. 13-15 illustrate some non-limiting examples of user interfaces or screens that may be presented by system 10 in order to create relationships between different content types. FIG. 13 illustrates one non-limiting example of an interface or screen 180 for creating a mapping between the retail product content type and the retail store content type. Screen 180 may be generated by system 10 when a user selects the “Content Relationships” icon on screen 160 of FIG. 11. Screen 180 allows a user to select the content type (e.g., retail stores) to which the “primary content” type (e.g., retail products) will be mapped. Selecting the “Next” icon on screen 180, will generate screen 190 of FIG. 14. Screen 190 allows a user to name the relationship (“ProductToStore”) and the relational database table (e.g., “ProductToStore”), which may designated for the relationship and stored within the memory of system 10. Screen 190 also allows a user to enter a description of the relationship table (e.g., “Store Level Product Inventory”), and to enter the content that will be stored within the primary columns of the table (e.g., retail products and retail stores). Below the foregoing entries, screen 190 includes a plurality of blank fields, in which the user may enter extended attributes of the relationship. The extended attributes may include a name (e.g., “Inventory”), a data type (e.g., integer, string), a data length, and a description. Once the relationship has been created, system 10 will create and store a relational database table for the relationship, and display the created relationship and its extended attributes, as shown in screen 200 of FIG. 15.

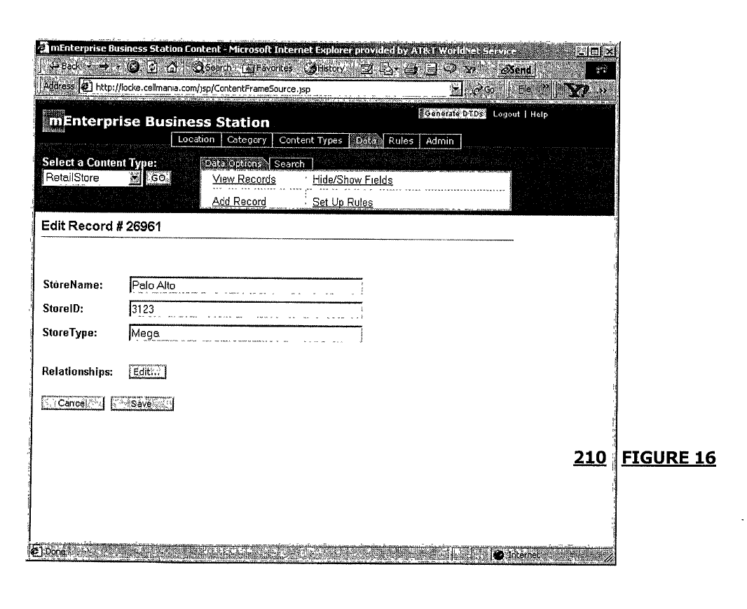

After the necessary or desired relationships have been created, a user will proceed to step 38, where the user will create specific data records within the various content types. That is, once a content type has been created, system 10 allows a user to define specific data records within that content type. Referring back to screens 160 and 170 of FIGS. 11 and 12, respectively, a user may select the box labeled “Data” to create data records within the displayed content type. For example, selecting the “Data” box within the retail store content type screen 170 causes the system 10 to generate a screen for defining data records that will represent specific retail stores. Screen 210 of FIG. 16 is one non-limiting example of such a screen. The screen 210 allows the user to enter data for each of the attributes defined and/or created for retail stores (i.e., “StoreName”, “StoreID” and “StoreType”), thereby creating unique data records representing the enterprise's various stores.

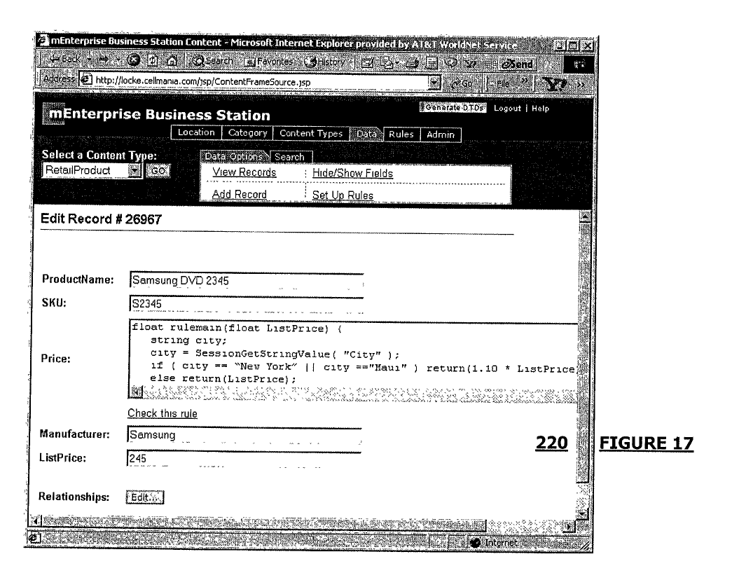

Screen 220 of FIG. 17 is a non-limiting example of a screen for creating a data record under the retail products content type. The screen 220 allows the user to enter data for each of the attributes defined and/or created for retail products (i.e., “ProductName”, “SKU”, “Price”, “Manufacturer” and “ListPrice”), thereby creating unique data records representing the enterprise's various products. As shown in screen 220, the list price of a product may be defined by a micro-rule, thereby allowing the price of the product to be vary based on location, time, and/or any other attributes. For example, a retailer may need or desire to charge more for certain products in certain areas of the United States, such as Manhattan, Alaska or Hawaii. In conventional systems, it is very difficult to capture store or region-based pricing (e.g., in convention systems, formulas are typically defined in the database using SQL, and cannot directly access user or session information unless passed in explicitly as attributes to the formula). However, in system 10, a retailer may simply define sales price as a micro-rule. For instance, sales price can be defined as a function of location, time, customer-type (for repeat or contractual customers versus regular consumers), quantity (for volume-based pricing), list price, and any other relevant factor. In the example shown in FIG. 17, the user has defined the price of a DVD player to be 10% higher than the list price if the city is Manhattan or Maui. As a result, whenever an end-user asks for the price of a DVD player, the value retrieved will depend upon the city in which the user resides or inquires.

A non-limiting example of “pseudo-code” that may be used to create this rule is shown below:

float rulemain(float listprice) {

string city;
city = SessionGetStringValue(“City”);

if the value of session variable named City is New York or Maui

then the sales prices is 1.10*listprice else listprice */

if(city = “New York” || city == “Maui”) {

return(1.10 * listprice);}

else return(listprice); }

After a data record for a content type is created, a user may proceed to step 40 and map the data record to locations within the location hierarchies and/or to other related content. In step 40, a user or enterprise may utilize system 10 to create two types of mappings. First, a user may map the data record to a location within the location hierarchies, such as mapping a particular retail store to a location within the retail distribution hierarchy. Second, a user may map a data record to another data record within a related content type (i.e., where a relationship has been created), such as mapping a product to a store.

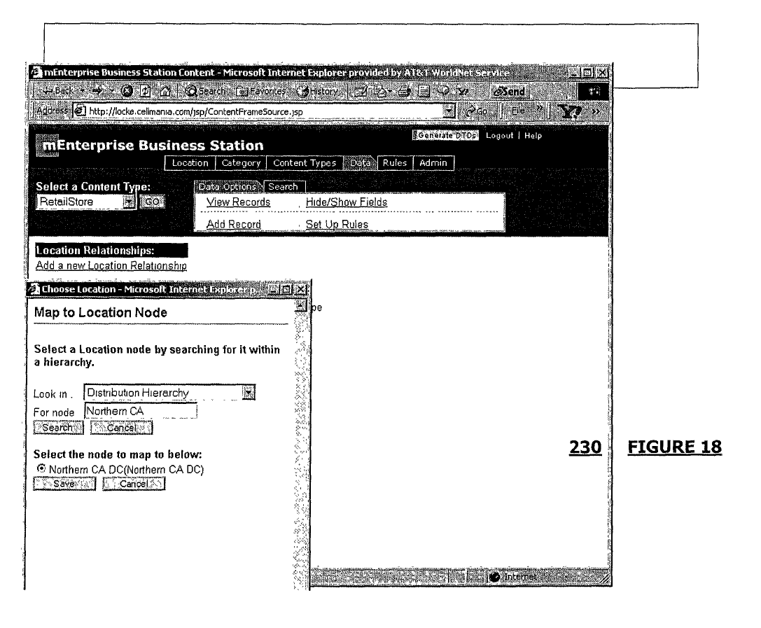

FIG. 18 illustrates one non-limiting example of a user interface or screen 230 for creating a mapping between a data record within the retail store content type and a location within the distribution hierarchy. Screen 230 may be generated by system 10 when a user selects the “Edit” relationships icon on screen 210 of FIG. 16. Screen 230 allows a user to select to select a hierarchy and a node within that hierarchy to which the retail store will be mapped. In the example shown, the Palo Alto store will be mapped to the Northern California node within the distribution hierarchy. By repeating this procedure, a user or enterprise can map each of its stores to particular distribution areas or regions. In alternate embodiments, system 10 may also allow a user to map data records to additional (e.g., lower) levels within the hierarchy (e.g., retail stores may be mapped to particular ZIP codes within the distribution hierarchy). When a user selects the “Save” icon, system 10 will store the created mapping within its memory.

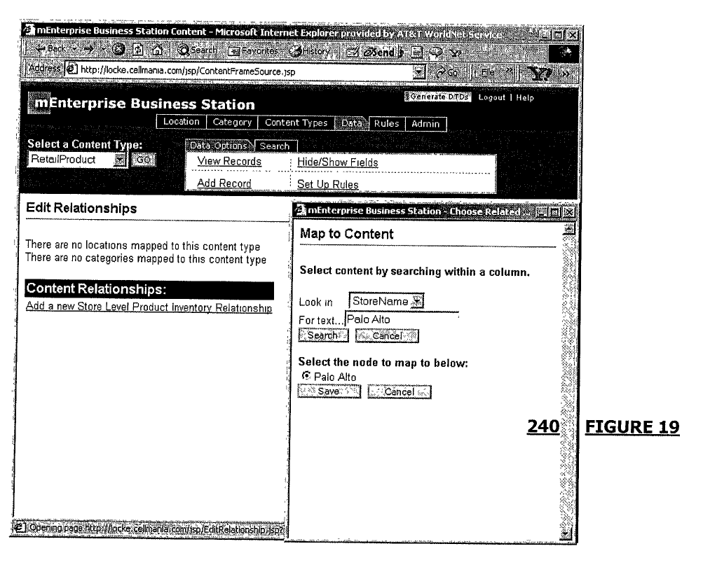

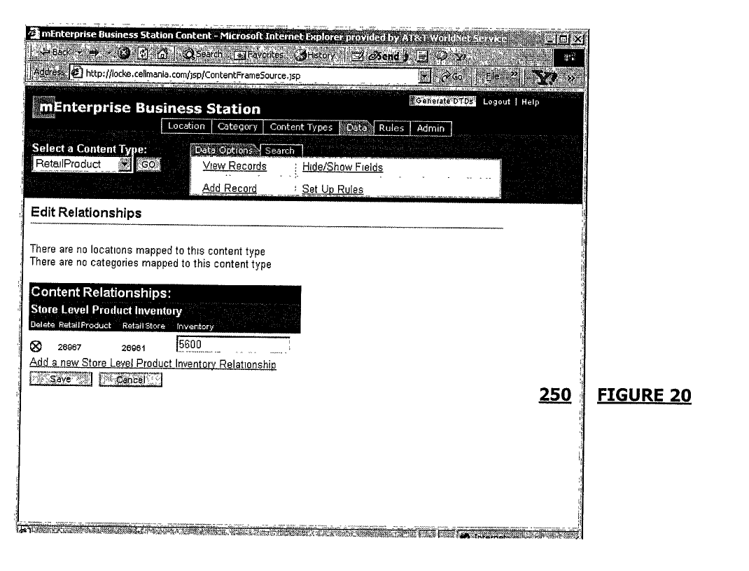

FIG. 19 illustrates one non-limiting example of a user interface or screen 240 for creating a mapping between data records of different content types. For example, between a data record within the retail product content type and a data record within the retail store content type. Screen 240 may be generated by system 10 when a user selects the “Edit” relationships icon on screen 220 of FIG. 17, and a relationship has been created for the content type of the data record. In the example shown, the relationship that has been created (retail products and retail stores) will cause system 10 to generate screen 240 when the “Edit” relationships icon on screen 220 is selected. Screen 240 allows a user to select a particular store (e.g., by store name) to which the particular product will be mapped. In the example shown, the DVD player defined in screen 220 of FIG. 17 will be mapped to the Palo Alto store defined in screen 210 of FIG. 16. System 10 will then generate another screen, such as screen 250 of FIG. 20, which will allow the user to fill in data relating to any extended attributes of the relationship. In the example shown, the screen 250 allows the user to enter an integer value (e.g., 5600) representing the amount of inventory of the particular product (e.g.,. the DVD player) within the particular store (e.g., the Palo Alto store). An enterprise can repeat this procedure to map product inventories or quantities to each of its stores that carry the product. When a user selects the “Save” icon, system 10 will store the created relationship or mapping within its memory.

Once a user has completed the mapping step, the user may proceed to step 40, and employ system 10 to create “macro-rules.” A macro-rule is a rule that is applied to rows of data or data records that are returned from a query. The system 10 supports both pre-query and post-query macro-rules. Pre-query macro-rules are rules that are applied before a query is run, and post-query rules are rules that are applied after a query is run. An example of a pre-query rule is to fix the value of a session variable such as customer status so that session variable can later be used in a post-query rule. An example of a post-query rule is an ordering of products returned by price, or a filtering of products so that only products less than a certain price are returned. Macro-rules may be applied to a content type or to a content-to-content relationship.

In the system 10, macro-rules may be based upon time, which may be defined as either fixed, relative to the user, or relative to the system. For example, time-based promotions can be created in this manner in system 10. For example, a post-query macro-rule can be designed to allow a store to have a special promotion in the Northern California DMA in the month of December, with the relevant promotion time defined in the following manners:

(i) Fixed: such as “2001 12 15 0900 PST,” i.e., 9 a.m. Pacific Standard Time on Dec. 15, 2001. This may be useful for an event that is going to happen or has happened in one place.

(ii) Relative to an end-user: such as “2001 12 15 0900,” i.e., 9 a.m. set in the user's time zone, wherever the user happens to be. In this manner, a promotion may be set to run from 8 a.m. to 12 a.m. in each time zone.

(iii) Relative to the system: such as “2001 12 15 0900,” i.e., 9 a.m. on Dec. 15, 2001 in the system's time zone, where the system 10 is installed. In this manner, a promotion may be set to run 8 a.m. to 12 a.m. in the time zone where the enterprise's headquarters is located.

Each content type in system 10 may have one or more attributes that are based on the time data type. Time can also be used within micro and macro rules in system 10. Finally, various operations can be applied to time elements including but not limited to equal to, less than, and greater than operations.

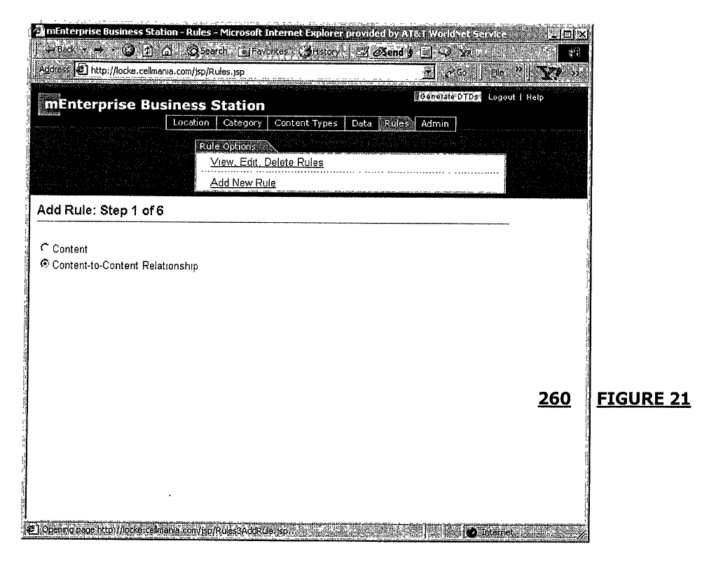

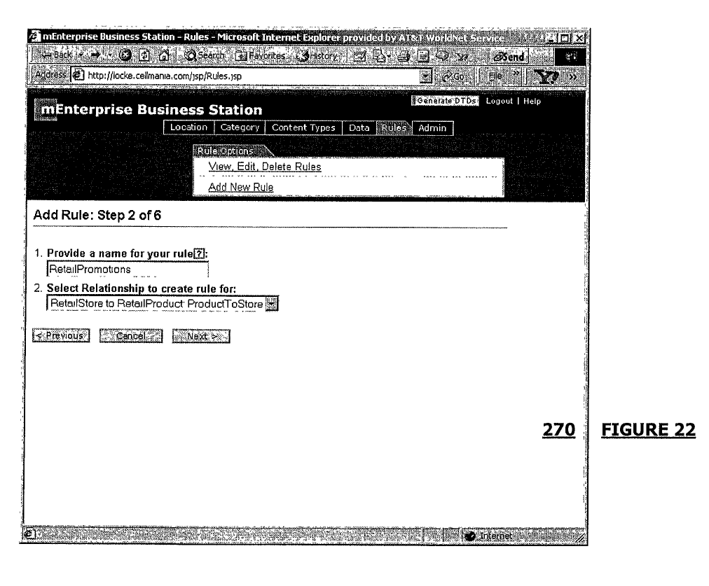

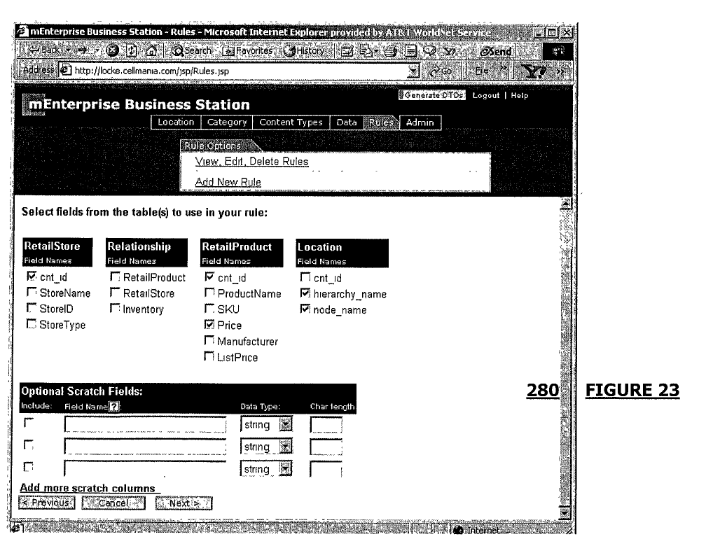

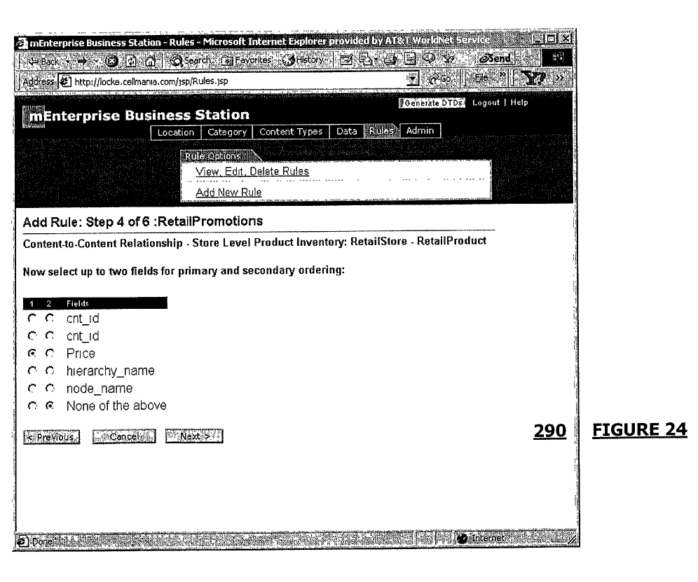

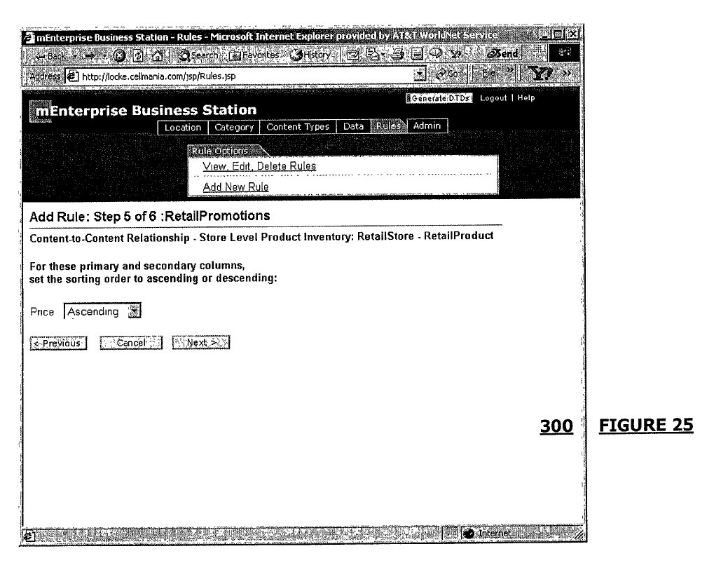

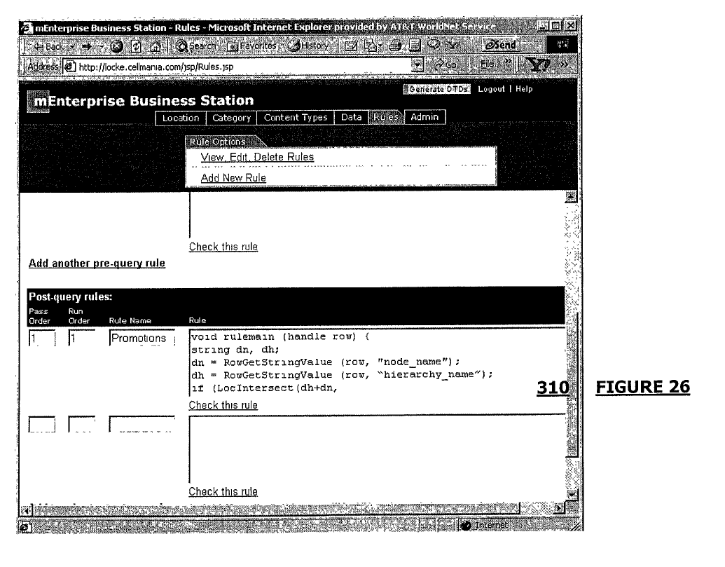

FIGS. 21-26 illustrate a series of sample screens that may be generated by system 10 for the creation of a macro-rule. FIG. 21 illustrates a screen 260 that may be generated by system 10 to allow a user to select between creating a content-based macro-rule or a relationship-based macro-rule. The subsequent screen 270 of FIG. 22 allows a user to enter a name for the macro-rule (e.g., “Retail Promotions”), and the relationship to which the rule will apply (e.g., the retail store to retail product relationship). Next, the user will select the attributes that will be used in the macro-rule. The attributes may be selected from the attributes of each content type, from the extended attributes of the relationship, and from the attributes of location hierarchies. Screen 280 of FIG. 23 may be generated by system 10 to provide for this selection. As shown in screen 280, the attributes needed for the macro-rule are retail store content identification, retail product content identification, price, hierarchy name, and node name within the hierarchy. Next, system 10 may generate a screen, such as screen 290 of FIG. 24, for the user to select one or more fields or attributes for ordering or arranging query results. In the present example, the attribute selected is price. The system 10 may then generate another screen to allow the user to select a manner of ordering the results based upon the attribute, such as in descending or ascending order. Screen 300 of FIG. 25 is an example of a screen that may be used for this selection, and illustrates the attribute of price, which will be used to arrange query results by ascending price. In the next and final step, the user defines the macro-rule. Screen 310 of FIG. 26 illustrates a screen that may be generated to define a macro-rule.

In the promotions example, the previously described post-query macro-rule, which allows a store to have a special promotion in the Northern California DMA in the month of December, may be defined by the following pseudo-code:

void rulemain (handle row) {
string dn, dh;
/*Get the value of the distribution area mapped to the store */
dn = RowGetStringValue (row, “node_name”);
/*Get the name of the distribution hierarchy */
dh = RowGetStringValue (row, “hierarchy_name”);
/* If there is a location intersection between the Distribution Area and

Northern California in the advertising hierarchy 52 and the user's time is
In the month of December 2001 then apply a 10% discount */

if (LocIntersect(dh+dn, “Advertizing Hierarchy|Northern California”)
&& SessionGetDateValue(“MyTime”) >= “2001 12 01 00:01”
&& SessionGetDateValue(“MyTime”) <= “2001 12 31 23:59”)
RowSetFloatValue (row, “price”, 0.9 * RowGetFloatValue(row, “price”));
}

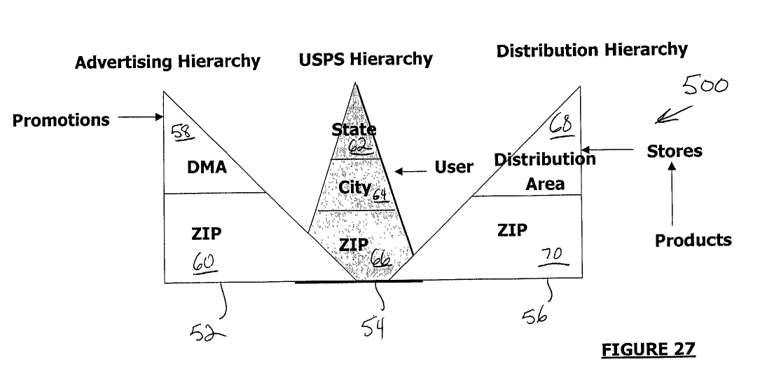

Once all hierarchies, content types, relationships, data records, micro-rules and macro-rules have been defined, the system 10 will have created a dynamic, relational data system that may be altered and queried in a quick and efficient manner, where such alterations can be made while the system is being queried. FIG. 27 illustrates a graphical representation of a dynamic, relational data system 500 that may be created by a user of system 10. As shown in FIG. 27, promotions have been mapped into the advertising hierarchy 52, products have been mapped to retail stores, and retail stores have been mapped into the distribution hierarchy 56. The created system 500 may then be used to interact with end-users, as set forth in step 42, thereby enabling an enterprise to provide meaningful information to its end-users in a fast and simple manner.

In operation, the relational data system created by system 10 may be used to interact with end-users, and to provide answers to complicated queries. For instance, the system and data structure 10 may allow customers to evaluate intersections between nodes at different levels in the defined location hierarchies. For example, system 10 may receive a location intersection query to find all the stores in a certain distribution area, such as the San Francisco Bay area. Location intersections can be invoked during a query, micro-rule or macro-rule.

In response to a location intersection query, system 10 will use the USPS hierarchy 54 to find all the low level regions (in this case ZIP codes) which are contained within the specified region. In the present example the specified region (e.g., the San Francisco bay area) may be determined in a conventional manner by the end-user's session (e.g., by data received from the wireless network on which the end-user is logged). The system 10 will locate all ZIP codes within the user's city using the USPS hierarchy 54. System 10 will then query the retail stores content type and return all the stores that are mapped to the distribution areas (using the retail store to distribution hierarchy mapping) that cover those ZIP codes (using the distribution hierarchy).

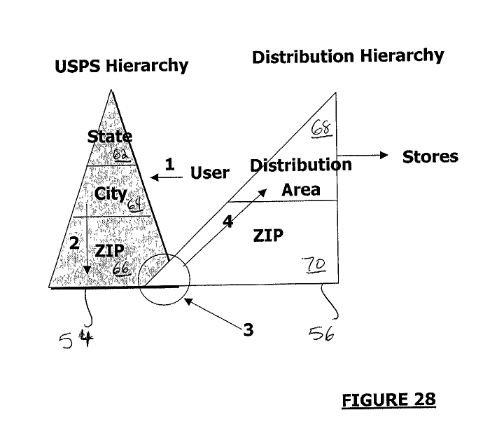

FIG. 28 is a graphical representation illustrating an example of the operational flow of system 10 in determining the location intersection of first data records, which define an end-user's city, and second data records, which define stores within the distribution areas serving the end-user's city. In step 1 of FIG. 28, the system 10 locates the user's city from session data (e.g., from data provided by network 20). In step 2, the system 10 locates all relevant ZIP codes (i.e., ZIP codes within that city) from the USPS hierarchy 54. In step 3, the system 10 locates the relevant ZIP codes from step 2 in the distribution hierarchy 56. In step 4, the system 10 determines the distribution areas that are mapped to those ZIP codes and returns the stores that are mapped to those distribution areas.

The system 10 further allows end-users to query for any content type and return one or more attributes of the content type. Macro-rules can be associated with queries (i.e., pre or post execution of query), while micro-rules are run while the data is being queried.

For further example, in a consumer electronics retail environment, an end-user may want to find out the prices of all products (e.g., DVD players) that are available in the stores near the end-user's city. While appearing simple, this query is actually very complicated. Particularly, the following factors have to be taken into account to answer the request.

(i) Which stores serve the end-user's city? The example assumes that stores are organized by the Distribution Areas that they serve. Each Distribution Area in turn is comprised of a set of ZIP codes, which may cross city boundaries.

(ii) What products do those stores have in inventory?

(iii) Are there any regional, time-based or customer-based differences in the pricing of those products?

(iv) Are there any applicable promotions on those products at the present time for those products? The example assumes that retail stores do advertising on a gross-regional level known as direct marketing areas or DMAs.

In this example, the previously described hierarchies, content types, relationships and mappings, and rules were setup within the system 10. That is, stores and products were defined as content types. Stores were given attributes of store name, ID, address and store type, and products were given attributes of product name, list price, sales price, manufacturer and SKU. Promotions were mapped to the advertising hierarchy 52.

In system 10, the desired information may be retrieved by a single query defined, whereas prior systems would requires the use of four separate queries, such as:

a. Find stores closest to the user's city

b. Find the products that are in stock in those stores

c. Apply any location and time based differences to the product pricing

d. Apply the promotions relevant to the location

Particularly, the present system 10 can solve the same problem by use of the following single query specified in pseudo-code as:

Query Product price, Store distribution_area

with Promo macro-rule

from Products, Stores

where Inventory (Products, Stores)>0 and

Location Intersects(USPS Hierarchy Session(city)

Where Promo rule is defined as

float rulemain(float listprice) {

string city;
city = SessionGetStringValue(“City”);

if the value of session variable named City is New York or Maui

then the sales prices is 1.10*listprice else listprice */

if( city == “New York” || city == “Maui”) {

return(1.10 * listprice);}

else return(listprice);}

The foregoing query will be executed within the system 10 as follows. System 10 queries the retail store content type for those stores that have a location intersection with the user's city. The user's city may be provided in a conventional manner from the network 20 that the user is logged onto, or may be provided by the end-user in response to a query. The system 10 uses the USPS hierarchy 54 to find all the ZIP codes in the end-user's city. The system 10 then queries the retail stores content type and returns all the stores that are mapped to distribution areas (using the retail store to distribution hierarchy mapping) that cover the ZIP codes identified in the user's city.

The system 10 then retrieves all products that are mapped to those stores where the inventory level is greater than zero. The system 10 will then compute the list price of each of the retrieved products using the micro-rule defined above. The objective of the micro-rule is to apply a 10% surcharge to DVD players in New York and Maui cities.

The system 10 will then execute the promotional (“Promo”) macro-rule on the returning sets of products and distribution area locations. The objective of the Promo macro-rule is to apply a 10% discount in the month of December. This is in turn accomplished by:

a. Finding, from the list of distribution areas returned by the query, those that overlap with the Northern California node in the advertising hierarchy 52.

b. Checking to ensure that the time in the user's session is in the month of December 2001. Note, in this example the promotion the time is calculated relative to the user's session time, so that for one minute past midnight EST on December 31, the promotion will have expired for users in EST time zone but not for others.

c. Setting the sales price column to 90% of its previous value if the promotion applies.

It should be appreciated that any other types of queries may be performed using system 10 in a similar manner. It should further be appreciated that system 10 may be employed to receive the time and location that an end-user enters a wireless network, and based on the end-user's location, to transmit location and time-based data (e.g., promotions to the end-user). For instance, the system 10 may transmit to the end-user certain advertisements or promotions that are being offered in the end-user's area at that particular time.

The system 10 provides a location and time-based engine that performs location intersects on user-definable location hierarchies and user-definable content mapped to those hierarchies; performs such location intersect queries in a very fast and reliable manner; allows the retrieved data to be defined dynamically by the user of micro-rules and macro-rules (i.e., dynamic data based on formulas), and provides the ability to support absolute, user-relative and system-relative times.

It should be understood that the inventions described herein are provided by way of example only and that numerous changes, alterations, modifications, and substitutions may be made without departing from the spirit and scope of the inventions as delineated within the following claims.

what is claimed is:

1. A system for managing and utilizing location-based information, said system being adapted to create a plurality of interrelated location hierarchies, to create a plurality of data types each having user-definable attributes, to create data records within said plurality of data types by providing values for said user-definable attributes, to map said data records into said location hierarchies, to create relationships between said data types and records, and to perform location intersect queries for quickly retrieving data records.

2. The system of claim 1 wherein said system is adapted to perform said location intersect queries by determining an overlap between a first data record in a first location hierarchy and at least one second data record in a second location hierarchy.

3. The system of claim 1 wherein said system is adapted to perform said location intersect queries by determining an overlap between a first data type in a first location hierarchy and at least one second data type in a second location hierarchy.

4. The system of claim 1 wherein said system is adapted to perform said location intersect queries by determining an overlap between a first data type in a first location hierarchy and at least one first data record in a second location hierarchy.

5. The system of claim 1 wherein said system is further adapted to associate each of said data records with a time, wherein said time may be selectively defined as fixed, relative to a user, and relative to said system, and to further perform queries for quickly retrieving said data records based upon time.

6. The system of claim 1 wherein each of said attributes may be defined as fixed or as a dynamic rule that is embedded into the data record and that includes at least one variable, and wherein said system is further adapted to perform queries that run said dynamic rules in order to quickly retrieve data records.

7. The system of claim 1 wherein said system is adapted for use in a retail environment and wherein said plurality of interrelated location hierarchies comprises:
an advertising hierarchy for mapping promotions to particular marketing areas;
a geographic hierarchy containing uniform postal codes; and
a distribution hierarchy for mapping stores to particular distribution areas.

8. The system of claim 7 wherein said stores are defined by a first data type, wherein products are defined by a second data type, and wherein a relationship is created between said first and second data types, thereby associating products to stores.

9. The system of claim 8 wherein said relationship between said first and second data types includes an extended attribute representing inventories of said products within said stores.

10. A system for managing and utilizing time-based information, said system being adapted to create a plurality of data elements which may each be associated with a time, wherein said time may be selectively defined as fixed, relative to a user, and relative to said system, and to perform queries for quickly retrieving data elements based upon time.

11. The system of claim 10 wherein each of said data elements includes a plurality of user-definable attributes, wherein each of said attributes may be defined as fixed or as a dynamic rule that is embedded as part of the data element and that includes at least one variable, and wherein said queries are adapted to run said dynamic rules in order to quickly retrieve data elements.

12. The system of claim 11 wherein said system is further adapted to create a plurality of interrelated location hierarchies, to map said data elements into said location hierarchies, to create relationships between said data elements, and to perform location intersection queries for quickly retrieving data elements.

13. A system for managing and utilizing location and time-based information, said system being adapted to create a plurality of data elements each including a plurality of user-definable attributes, wherein each of said attributes may be defined as fixed or as a dynamic rule that is embedded as part of the data element and that includes at least one variable, and to perform queries that run said dynamic rules in order to quickly retrieve data elements.

14. The system of claim 13 wherein said at least one variable comprises time.

15. The system of claim 13 wherein said at least one variable comprises location.

16. A system for managing and utilizing location and time-based information comprising:
a first portion adapted to receive location information, and to create a plurality of interrelated location hierarchies based upon said location information;
a second portion adapted to receive content information, and to create a plurality of content types based upon said content information, each of said content types including a plurality of attributes;
a third portion adapted to receive relationship information, and to create relationships between different content types;
a fourth portion adapted to create data records within said plurality of content types, by providing values for attributes of said content types;
a fifth portion adapted to associate said data records to locations within said plurality of interrelated location hierarchies; and
a sixth portion adapted to receive location and time-based queries and to retrieve relevant data records, based upon said queries.

17. The system of claim 16 wherein said fourth portion is adapted to define attributes by use of micro-rules, which allow the value of said attributes to vary based upon at least one variable, and wherein said sixth portion is adapted to run said micro-rules to perform said queries.

18. The system of claim 17 wherein said at least one variable comprises time.

19. The system of claim 17 wherein said at least one variable comprises location.

20. The system of claim 16 further comprising:
a seventh portion adapted to create macro-rules that are applied to data records returned from a query.

21. The system of claim 20 wherein said macro-rules are adapted to arrange said data records in a user-selectable format.

22. The system of claim 16 wherein said system is adapted for use in a retail environment and wherein said plurality of interrelated location hierarchies comprises:
an advertising hierarchy for mapping promotions to particular marketing areas;
a geographic hierarchy containing uniform postal codes; and
a distribution hierarchy for mapping stores to particular distribution areas.

23. The system of claim 22 wherein said stores are defined by a first data type, wherein products are defined by a second data type, and wherein a relationship is created between said first and second data types, thereby associating said products and said stores.

24. The system of claim 23 wherein said relationship between said first and second data types includes an extended attribute representing inventories of said products within said stores.

25. A method for managing and utilizing location and time-based information comprising the steps of:
creating a plurality of interrelated location hierarchies;
creating a plurality of data types each having user-definable attributes;
creating data records within said plurality of data types by providing values for said user-definable attributes;
mapping said data records into said location hierarchies;
creating relationships between said data types and records; and
performing location intersect queries for quickly retrieving data records.

26. The method of claim 25 further comprising the steps of:
associating at least one of said data records with a time, wherein said time may be selectively defined as fixed, relative to a user, and relative to said system; and
performing queries for quickly retrieving said data records based upon time.

26. The method of claim 25 wherein each of said attributes may be defined as fixed or as a dynamic rule that is embedded into the data record, and further comprising the step of:
performing queries that run said dynamic rules in order to quickly retrieve data records.

27. The method of claim 26 wherein at least one of said dynamic rules is time-based.

28. The method of claim 26 wherein at least one of said dynamic rules is location-based.

29. The method of claim 26 further comprising the step of:
creating macro-rules that are applied to data records returned from a query, said macro-rules being adapted to change the value of attributes of said returned data records based upon business logic within said macro-rules.

30. A method for managing and utilizing location and time-based information comprising:
receiving location information from a user;
creating a plurality of interrelated location hierarchies based upon said location information;
receiving data from a user;
creating a plurality of data types each including a plurality of attributes, based upon said data;
creating relationships between different data types;
creating data records within said plurality of data types, by providing values for attributes of said plurality of data types;
associating said data records to times and to locations within said plurality of interrelated location hierarchies;
receiving location and time-based queries; and
retrieving relevant data records, based upon said queries.

31. The method of claim 30 further comprising the steps of:
defining attributes by use of micro-rules, which allow the value of said attributes to vary based upon at least one variable; and
running said micro-rules while performing said queries in order to quickly retrieve said data records.

32. The method of claim 31 further comprising the step of:
creating macro-rules that are applied to data records returned from a query, said macro-rules being adapted to change the value of attributes of said returned data records based upon business logic within said macro-rules, which is based upon an input selected from the group consisting of time and location.

33. The method of claim 31 further comprising the step of:
creating macro-rules for arranging said data records in a user-selectable format.
